(19) United States
(12) Patent Application Publication
(10) Pub. No.: US 2026/0337738 A1
(43) Pub. Date: Oct. 29, 2026

(54) AUSTENITIC STAINLESS STEEL SHEET, METHOD FOR PRODUCING SAME, AND PART

(71) Applicant: NIPPON STEEL Stainless Steel Corporation, Tokyo (JP)

(72) Inventors: Yoshitomo FUJIMURA, Tokyo (JP); Jun-ichi HAMADA, Tokyo (JP)

(73) Assignee: NIPPON STEEL Stainless Steel Corporation, Tokyo (JP)

(21) Appl. No.: 19/110,008

(22) PCT Filed: Nov. 2, 2023
(86) PCT No.: PCT/JP2023/039688

§ 371 Date: Mar. 7, 2025

(30) Foreign Application Priority Data
Nov. 4, 2022 (JP) 2022-177258

(51) Int. Cl. C22C 38/34; C21D 6/00; C21D 8/0221; C21D 8/0247; C21D 8/0278; C21D 9/46; C22C 38/00; C22C 38/02; C22C 38/04; C22C 38/06; C22C 38/42; C22C 38/44; C22C 38/46; C22C 38/48; C22C 38/50; C22C 38/52; C22C 38/54; C22C 38/58; C22C 38/60; C23G 1/08

(52) U.S. Cl. CPC C22C 38/34; C21D 6/004; C21D 6/005; C21D 6/007; C21D 6/008; C21D 8/0226; C21D 8/0236; C21D 8/0263; C21D 8/0278; C21D 9/46; C22C 38/001; C22C 38/002; C22C 38/005; C22C 38/008; C22C 38/02; C22C 38/04; C22C 38/06; C22C 38/42; C22C 38/44; C22C 38/46; C22C 38/48; C22C 38/50; C22C 38/52; C22C 38/54; C22C 38/58; C22C 38/60; C23G 1/086; C21D 2211/001

(57) ABSTRACT

The present invention has as its technical issue to suppress intergranular cracking resistance (nitriding resistance) and suppress even formation of red scale (oxidation resistance) even in a gas atmosphere containing nitrogen and water vapor such as ammonia combustion gas in a 500 to 700 °C medium and high temperature region and has as its object the provision of such austenitic stainless steel.

The present invention is an austenitic stainless steel sheet having a predetermined chemical composition, having a nitriding trend index of 15 or less, and having an Si oxide coating on the steel sheet surface present in an area ratio of 5% or more and is obtained by final annealing the steel sheet to form an internal oxidation layer (Si oxide layer) and removing the Cr oxide layer and Fe oxide layer of the surface layer by subsequent pickling to form an Si oxide layer on the surface layer:

Nitridation Trend Index=0.5Cr+10Al+2Mo+3Ti+0.5Cu−1.5Si

### FIELD

The present invention relates to austenitic stainless steel sheet, a method for producing the same, and a part using that austenitic stainless steel sheet.

### BACKGROUND

Global warming is becoming an international environmental issue. Intensive technical research is underway for realization of a carbon zero, carbon neutral, or other low carbon society. In such a trend, ammonia is being looked at as fuel for taking the place of carbon fuels. The formula for the combustion reaction of ammonia is 4NH₃+3O₂→2N₂+6H₂O. Hydrogen and nitrogen are produced and the environmental load is small, so much is expected from this as a recyclable fuel. The combustion temperature of ammonia is an adiabatic flame temperature of 1750 °C. This is lower than the 2120 °C of hydrogen, 1970 °C of methane, and the approximately 2000 °C of gasoline. The combustion temperature in actual engines or gas turbines also becomes lower compared with these existing fuels. For this reason, is using ammonia as fuel, the exhaust gas temperature also becomes a temperature of 500 to 700 °C or so lower than the case of existing fuel. This temperature region of 500 to 700 °C is a temperature at which the steel material used for exhaust pipes becomes easily oxidized and a temperature region in which so-called red scale is easily formed.

PTL 1 proposes austenitic stainless steel having excellent corrosion resistance even in an environment containing high sulfur (S) and high chlorine (Cl) such as a boiler superheater tube, garbage incinerator, or ammonia synthesis apparatus.

PTL 2 proposes austenitic stainless steel having excellent corrosion resistance without adding chromic acid by rendering the atmosphere an ammonia one in an ammonia-water based absorption heat exchanger.

### CITATIONS LIST

### Patent Literature

[PTL 1] Japanese Unexamined Patent Publication No. 3-126842
[PTL 2] Japanese Unexamined Patent Publication No. 10-280100

### SUMMARY

### Technical Problem

Use of ammonia as a fuel is being worked on not only for combustion alone, but also for mixed combustion with other fuels (heavy oil, light oil, hydrogen, etc.) However, while called “mixed combustion”, ammonia with a combustion temperature lower than existing fuels is added for combustion, so the temperature of the combustion exhaust gas becomes 500 to 700 °C or lower than existing fuels. Furthermore, the combustion gas of ammonia contains large amounts of nitrogen and water vapor.

Due to the inclusion of water vapor, oxidation by the water vapor or red scale easily arises. Furthermore, the temperature of the combustion gas is 500 to 700 °C or so or a temperature region in which red scale easily forms. For this reason, oxidation resistance (red scale resistance) is being sought in steel materials used for ammonia combustion gas etc.

Furthermore, due to the large amount of nitrogen contained in ammonia combustion exhaust gas, nitrogen penetrates the steel material surface layer (nitrides) leading to embrittlement due to intergranular cracking. For this reason, nitriding resistance (intergranular cracking resistance) is also being demanded in steel materials used for ammonia combustion gas etc.

The stainless steel of PTL 1 is described as being applicable to ammonia synthesis equipment, but this does not cover the combustion gas of ammonia (combustion exhaust gas). Countermeasures against intergranular cracking due to nitriding and red scale (oxidation) at 500 to 700 °C are not considered.

The stainless steel of PTL 2 is predicated on application to an ammonia-water based absorption heat exchanger, that is, contact with ammonia gas or an ammonia solution. Countermeasures against intergranular cracking due to nitriding and red scale (oxidation) at 500 to 700 °C are not considered.

The present invention has as its technical issue austenitic stainless steel having red scale resistance (oxidation resistance) and intergranular cracking resistance (nitriding resistance) even against gas containing large amounts of nitrogen and water (water vapor) at 500 to 700 °C or so such as ammonia combustion exhaust gas and has as its object the provision of such a steel material (austenitic stainless steel).

### Solution to Problem

To deal with this technical issue, the inventors engaged in intensive studies and obtained the following findings:

(a) From the viewpoint of suppressing nitriding, they thought that the contents of the elements promoting nitriding such as Cr, Mo, Ti, Al, and Cu should be optimized.

(b) Furthermore, they came up with the idea of forming red scale resistant and nitriding resistant coating at the steel material surface layer and discovered that having an Si oxide coating (SiO₂ coating) on the steel sheet surface is effective for red scale resistance and nitriding resistance. To secure red scale resistance and nitriding resistance, they discovered that an Si oxide coating may be formed on the steel sheet surface to 5% or more.

(c) Furthermore, they discovered that Si not only has a suppressive effect on red scale due to oxidation of water vapor, but also has the effect of suppression of nitriding, while the reason is not certain. They discovered that the nitriding trend index, which shows the nitriding trend of the steel material, may be derived from the contents of elements promoting nitriding such as Cr, Mo, Ti, Al, and Cu and the content of Si suppressing nitriding and this nitriding trend index may be made 15.0 or less.

Nitridation trend index=0.5Cr+10Al+2Mo+3Ti+0.5Cu−1.5Si≤15.0 (formula 1)

(d) The inventors also studied the method of suitably forming an SiO₂ coating on the steel material surface. As a result, they discovered that by forming an internal oxidation layer of SiO₂ below the surface of austenitic stainless steel having a predetermined composition and then forming a Cr oxide layer and iron oxide layer on the internal oxidation layer of the SiO₂, then pickling such a steel sheet to etch away the Cr oxide layer and iron oxide layer, it is possible to suitably leave an Si oxide coating on the surface layer.

The present invention was made based on these findings and has as its gist the following:

[1] Austenitic stainless steel sheet containing, by mass %,
C: 0 to 0.150%,
Si: 0.05 to 4.50%,
Mn: 0.05 to 3.00%,
P: 0.050% or less,
S: 0.0050% or less,
Ni: 8.00 to 21.00%,
Cr: 15.0 to 30.0%,
N: 0 to 0.350%,
Nb: 0 to 1.00%
Mo: 0 to 3.00%
Cu: 0 to 3.50%
Al: 0.002 to 0.800%,
Ti: 0 to 0.600%
V: 0 to 1.00%,
B: 0 to 0.0100%,
Ca: 0 to 0.0150%
Sn: 0 to 1.00%,
Hf: 0 to 0.60%,
Zr: 0 to 0.60%,
Sb: 0 to 0.60%,
Co: 0 to 1.50%,
W: 0 to 2.00%,
Ta: 0 to 1.00%,
Ga: 0 to 0.50%,
Mg: 0 to 0.0050%, and
REM: 0 to 0.20%,
satisfying formula 1,
comprising a balance of Fe and impurities,
satisfying the following formula 1, and
having an Si oxide coating on the surface, when viewing the steel sheet surface from vertically above, present in an area % of 5.0% or more:

0.5Cr+10Al+2Mo+3Ti+0.5Cu−1.5Si≤15.0 (formula 1)
where, the symbols of elements in formula 1 indicate the contents (mass %) of those elements, 0 being entered when not contained.
   [2] The austenitic stainless steel sheet according to [1], wherein particle size 1 μm or more Si oxides are present in an area ratio of 3.0% or more at a cross-section vertical to the steel sheet surface in a region of a width of 30 μm down 10 μm from the steel sheet surface in the steel sheet thickness direction.
   [3] The austenitic stainless steel sheet according to [1] or [2], wherein a range of 50 m square at a cross-section in a sheet thickness direction of the steel sheet is made one field and a total of lengths of intergranular cracks of any three fields is 15 μm or less.
   [4] The austenitic stainless steel sheet according to any one of [1] to [3], wherein the Si oxide coating is present in an area ratio of 50% or less.
   [5] The austenitic stainless steel sheet according to any one of [1] to [4], for use for ammonia combustion equipment.
   [6] The method for producing austenitic stainless steel sheet according to any one of [1] to [4], the method for producing austenitic stainless steel sheet comprising, after final cold rolling, heating and holding steel sheet having a composition according to [1] to 900 to 1100 °C, then cooling the steel sheet to a 50 °C or less temperature and pickling the steel sheet in a pickling solution containing fluoric acid 2.0% or less and nitric acid 6 to 15% and having a temperature of 50 to 60 °C for 40 to 60 seconds in a pickling step.
   [7] The method for producing austenitic stainless steel sheet according to [6], further comprising brushing at least part of the steel sheet surface after the pickling step.
   [8]A part having, at least portion thereof, the austenitic stainless steel sheet according to any one of [1] to [4].
   [9] The part according to [8], which is a part for ammonia combustion equipment.

### Advantageous Effects of Invention

Due to the austenitic stainless steel according to the present invention, it is possible to obtain stainless steel sheet excellent in corrosion resistance and wear resistance even if coming into contact with a gas like ammonia combustion exhaust gas with a temperature of 500 to 700 °C or so containing nitrogen and water (water vapor) in large amounts. Furthermore, austenitic stainless steel has a smaller coefficient of thermal expansion and therefore a smaller thermal fatigue compared with ferritic stainless steel and further is also excellent in high temperature strength and high temperature corrosion resistance. Therefore, the austenitic stainless steel according to the present invention is an extremely effective material in an environment in which corrosion resistance and strength are required at a high temperature while, like ammonia combustion exhaust gas, nitrogen and water vapor are contained in large amounts.

### DESCRIPTION OF EMBODIMENTS

Below, one embodiment of the present invention (below, simply called the “present invention”) will be explained. Unless particularly otherwise indicated, the “%” relating to the composition will indicate the mass % in the steel. If no lower limit is particularly prescribed or if the lower limit becomes 0%, the case of non-inclusion (0%) is also included.

### <Regarding Steel Composition>

### C: O to 0.150%

C is an element causing a drop in the shapeability (r-value), so the less, the better. The upper limit is made 0.150%. From the viewpoint of the shapeability, 0.140% or less, 0.120% or less, or 0.100% or less is preferable. The lower limit is not particularly prescribed, but excessive reduction would lead to a rise in the refining costs, so 0.001% or more is preferable. More preferably it may be made 0.002% or more.

### Si: 0.05 to 4.50%

Si is an element effective for suppressing oxidation, in particular water vapor oxidation, and effective for suppression of nitriding. Furthermore, from the viewpoint of formation of an SiO₂ internal oxidation layer right below the steel sheet surface, 0.05% or more is contained. The lower limit of Si preferably may be made 0.10%, 0.20%, 0.30%, 0.50%, 0.80%, 1.00%, 1.25%, 1.50%, 1.70%, 1.90%, 2.00%, 2.20%, 2.40%, 2.50%, or 2.60%. On the other hand, if the Si content is increased, the area ratio of the Si oxide layer (or SiO₂ internal oxidation layer) increases and the workability and weldability deteriorate, so 4.50% is made the upper limit. The upper limit of Si preferably may be made 4.30%, 4.10%, or 4.00%.

### Mn: 0.05 to 3.00%

Mn, like Si, is an element effective for oxidation resistance, so 0.05% or more may be contained. The lower limit of Mn preferably may be made 0.07%, 0.10%, 0.13%, or 0.15%. On the other hand, if containing a large amount of Mn, the workability deteriorates, so 3.00% or less may be contained. The upper limit of Mn preferably may be made 2.80%, 2.60%, 2.50%, or 2.40%.

### P: 0.050% or Less

P causes the toughness and hot workability and the corrosion resistance to drop and is otherwise harmful to stainless steel, so the less, the better. The content may be made 0.050% or less, preferably may be made 0.040% or less. However, excessive reduction increases the load at the time of refining or requires the use of expensive materials, so practically 0.001% or more may be contained.

### S: 0.0050% or Less

S causes the toughness and hot workability and the corrosion resistance to drop and is otherwise harmful to stainless steel, so the less, the better. The content may be made 0.0050% or less, preferably may be made 0.0030% or less. However, excessive reduction increases the load at the time of refining or requires the use of expensive materials, so practically 0.0001% or more may be contained.

### Ni: 8.00 to 21.00%

Ni is an element causing stabilization of the austenite phase. It acts to improve the corrosion resistance to various acids and further the low temperature toughness, so 8.00% or more may be contained. Preferably, 9.00% or more, 10.00% or more, or 11.00% or more may be contained. On the other hand, it is an expensive element, so even if contained in a large amount, an effect commensurate with the increase in alloy costs cannot be obtained, so the content may be made 21.00% or less, preferably may be made 20.00% or less or 18.00% or less.

### Cr: 15.0 to 30.0%

Cr is an important element giving rise to corrosion resistance in stainless steel and may be contained in 15.0% or more, preferably may be made 15.5% or more, 16.0% or more, 17.0% or more, 18.0% or more, 19.0% or more, or 20.0% or more. On the other hand, inclusion in a large amount invites a drop in workability, so the content may be made 30.0% or less, preferably may be made 29.0% or less, 28.0% or less, 27.0% or less, or 26.0% or less.

### N: 0 to 0.350%

From the viewpoint of suppressing intergranular cracking due to surface N, the less the N inherently contained in the steel material, the better. Further, N causes the workability to fall and bonds with Cr to cause a drop in the corrosion resistance, so the less the better. The content may be made 0.350% or less, preferably may be made 0.300% or less, 0.280% or less, 0.260% or less, 0.240% or less, 0.220% or less, or 0.200% or less. On the other hand, excessive reduction places a great load on the refining process, so preferably it may be contained in 0.001% or more, 0.005% or more, or 0.010% or more.

### Nb: 0 to 1.00%

Nb acts to increase the shapeability and corrosion resistance. On the other hand, if adding more than 1.00%, recrystallization becomes difficult and the structure becomes coarse, so the content may be made 1.00% or less, preferably may be made 0.90% or less, 0.80% or less, or 0.70% or less. The lower limit of the Nb content is not particularly prescribed, but to reliably obtain this effect, it preferably may be contained in 0.01% or more.

### Mo: 0 to 3.00%

Mo, by addition, acts to further raise the high corrosion resistance of stainless steel. On the other hand, it is an element promoting nitriding. It forms a fragile sigma phase with high Cr thereby inviting embrittlement and a drop in the corrosion resistance, so the content may be made 3.00% or less, preferably may be made 2.50% or less 2.20% or less. The lower limit of the Mo content is not particularly prescribed, but to reliably obtain the effect of corrosion resistance, it preferably may be contained in 0.01% or more.

### Cu: 0 to 3.50%

Cu, by addition, acts to further raise the high corrosion resistance of stainless steel. On the other hand, excessive addition does not improve the performance commensurate with the manufacturing cost, so the content may be made 3.50% or less, preferably may be made 3.20% or less, 3.00% or less, or 2.80% or less. The lower limit of the Cu content is not particularly prescribed, but to reliably obtain the effect, it preferably may be contained in 0.01% or more.

### Al: 0.002 to 0.800%

Al is an element which bonds with N to form AlN and promotes nitriding. Furthermore, excessive addition causes the workability to drop, so the Al content may be made 0.800% or less, preferably may be made 0.750% or less, 0.700% or less, 0.600% or less, 0.500% or less, 0.400% or less, 0.300% or less, or 0.200% or less. On the other hand, it has the effect of desulfurization and improvement of the corrosion resistance, so the Al content may be made 0.002% or more, preferably may be made 0.004% or more, 0.006% or more, or 0.008% or more.

### Ti: 0 to 0.600%

Ti secures corrosion resistance due to the stabilizing actions of C and N. On the other hand, Ti is an element promoting nitriding. If excessively added, TiN is remarkably formed and invites nozzle clogging at the time of production and surface defects of the product, so the content may be made 0.600% or less, preferably may be made 0.500% or less, 0.400% or less, or 0.300% or less. The lower limit of the Ti content is not particularly prescribed, but to reliably obtain the effect, it preferably may be contained in 0.0010% or more.

### V: 0 to 1.00%

V, if added, acts to further increase the high corrosion resistance of stainless steel. On the other hand, if included in a high concentration, it invites a drop in the toughness, so the upper limit may be made 1.00%, preferably may be made 0.90% or less, 0.70% or less, or 0.50% or less. The lower limit of the V content is not particularly prescribed, but to reliably obtain the effect, it preferably may be contained in 0.010% or more or 0.05% or more.

### B: 0 to 0.0100%

B is an element raising the intergranular strength and contributes to improvement of the workability. On the other hand, excessive addition conversely invites a drop in workability due to the drop in ductility, so the content may be made 0.0100% or less, preferably may be made 0.0090% or less, 0.0070% or less, or 0.0050% or less. The lower limit of the B content is not particularly prescribed, but to reliably obtain the effect, it preferably may be contained in 0.0001% or more or 0.0005% or more.

### Ca: 0 to 0.0150%

Ca, if contained in a large amount, rises in concentration of oxides for promoting the formation of TiN. To eliminate that ability, 0.0150% or less may be contained. Preferably, it may be made 0.0120% or less, 0.0090% or less, 0.0070% or less, or 0.0050% or less. The lower limit is not particularly prescribed, but Ca is the main constituent of slag. Some entrainment is unavoidable. Further, complete removal is difficult. Excessive reduction increases the load at the time of the refining, so in actual operation, 0.00010% or more or 0.0002% or more may be contained.

### Sn: 0 to 1.00%

Sn, if added, acts to further increase the high corrosion resistance of stainless steel. On the other hand, excessive addition leads to a drop in the workability, so the content may be made 1.00% or less, preferably may be made 0.70% or less, 0.50% or less, or 0.30% or less. The lower limit of the Sn content is not particularly prescribed, but to reliably obtain the effect, it preferably may be contained in 0.001% or more or 0.002% or more.

In addition, further, by mass %, Hf: 0 to 0.600%, Zr: 0 to 0.600%, Sb: 0 to 0.600%, Co: 0 to 1.500%, W: 0 to 2.000%, Ta: 0 to 1.000%, Ga: 0 to 0.500%, Mg: 0 to 0.0050%, and REM: 0 to 0.200% may be contained. These elements act to raise the corrosion resistance of stainless steel by addition. On the other hand, they are expensive elements, so even if excessively contained, an effect commensurate with an increase in cost cannot be obtained, so the upper limit was provided. The lower limits of contents of these elements are not particularly prescribed, but to reliably obtain the effects of inclusion, preferably Mg may be contained in 0.0001% or more and elements other than Mg may be contained in respectively 0.001% or more.

The balance of the above steel composition is comprised of Fe and impurities. Here, “impurities” mean constituents such as ore, scraps, and other raw materials entering due to various factors in the production process when industrially producing steel and allowed to an extent not detrimentally affecting the present invention.

### <Nitridation Trend Index>

In optimizing the steel composition from the viewpoint of suppressing nitriding of the steel, the inventors thought of the relationship of the contents of the elements affecting nitriding. As elements promoting nitriding, Cr, Mo, Ti, Al, and Cu are known, but a certain amount may also be contained in securing the corrosion resistance and other functions of the stainless steel. Furthermore, the inventors discovered that Si, an important element contained in the steel according to the present invention, has not only an effect of suppressing red scale due to water vapor oxidation, but also an effect of suppressing nitriding due to an uncertain cause. Further, while explained later, it is also effective to form an Si oxide coating (SiO₂ coating) on the steel surface. Therefore, they thought of combining these elements promoting nitriding of Cr, Mo, Ti, and Al with Si with the effect of suppression of nitriding with a good balance and discovered that in the case of austenitic stainless steel, 0.5Cr+10Al+2Mo+3Ti+0.5Cu−1.5Si can be used for evaluation as an indicator showing the nitriding trend. From the viewpoint of suppression of nitriding, they discovered that the nitriding trend index may be 15.0 or less.

Nitridation Trend Index=0.5Cr+10Al+2Mo+3Ti+0.5Cu−1.5Si≤15.0 (formula 1)
where, the symbols of elements in formula 1 indicate the contents (mass %) of those elements, 0 being entered when not contained.

The nitriding trend index, in a word, is an indicator of ease of nitriding. The smaller the value, the better. For this reason, the upper limit of the nitriding trend index preferably may be made 14.5, 14.0, 13.5, 13.0, 12.5, 12.0, 11.5, 11.0, or 10.0.

### <Area Ratio of Surface Si Oxide Coating (SiO₂ Coating)>

The steel sheet surface may have an Si oxide coating (SiO₂ coating) present on it. This is because the part where the Si oxide coating is present is not penetrated by nitrogen (N) even if coming into contact with it and is suppressed in nitriding. For this reason, at the steel sheet surface, the Si oxide coating may be present in an area ratio of 5.0% or more. Preferably it may be made 6.0% or more, 7.0% or more, 8.0% or more, 9.0% or more, 10.0% or more, 11.0% or more, 12.0% or more, 13.0% or more, 14.0% or more, or 15.0% or more. The Si oxide coating is not particularly set with an upper limit of the area ratio. However, an Si oxide coating harms the luster and design property of stainless steel and, further, causes the workability and weldability to deteriorate. For this reason, at the steel sheet surface, the Si oxide coating may be present in an area ratio of 50.0% or less. Preferably it may be made 45.0% or less, 40.0% or less, 35.0% or less, 30.0% or less, 25.0% or less, or 2.0% or less. The Si oxide coating of the present invention is obtained by exposing the Si oxides internally oxidized in the production process at the steel sheet surface by removal of the Fe-based and Cr-based oxides at the surface. Therefore, these Si oxides differ from the Si oxides of the amorphous structure in the FeCr-based oxide layer (passive coating).

The area ratio of the Si oxide coating of the steel sheet front surface can be measured in the following way. At the front surface of the stainless steel sheet to be measured, a 30 μm square region is set as the observed field. This observed surface is analyzed by EPMA. In the oxides formed at the surface, the part with an Si content of 5 wt % or more is deemed the Si oxide coating, its area is measured, and the area ratio in the observed field is calculated. In the same stainless steel sheet, it may be found by selecting any three or more observed fields and finding the arithmetic average of the area ratios of the Si oxide coatings obtained there. The method of measurement of the area is not particularly limited, but a photo obtained by EPMA may be input into photo editing software (for example, ImageJ), the photo digitized, and measurement performed by image processing software.

### <Area Ratio of Si Oxides in Surface Layer>

The steel sheet surface layer may also have Si oxides (SiO₂) present on it. The “steel sheet surface layer” indicates the region from the steel sheet surface down to 10 m in the sheet thickness direction. This is because due to presence of Si-based oxides in the steel sheet surface layer, penetration of nitrogen (N) into the steel is prevented and nitriding is suppressed. For this reason, at the steel sheet surface layer, particle size 1 μm or more Si oxides may be present in an area ratio of 3.0% or more in a width 30 m observed surface. Preferably, the ratio may be made 4.0% or more, 5.0% or more, 6.0% or more, 7.0% or more, 8.0% or more, 9.0% or more, or 10.0% or more. The upper limit of the number of Si oxides at the width 30 μm observed surface is not particularly prescribed. However, Si oxides of the steel sheet surface layer cause the workability and weldability to deteriorate. For this reason, at the steel sheet surface layer, in a width 30 μm observed surface, particle size 1 μm or more Si oxides may be present in an area ratio of 20.0% or less. Preferably, the ratio may be made 19.0% or less, 18.0% or less, 17.0% or less, 16.0% or less, or 15.0% or less. The Si oxides at the steel sheet surface layer are oxides formed by internal oxidation in the production process. Therefore, these differ from the amorphous structure Si oxides in the FeCr-based oxide layer (passive coating).

The area ratio of the Si oxides at the steel sheet surface layer can be measured in the following way. At the cross-section vertical to the steel sheet surface of the stainless steel sheet to be measured, any rectangular observed surface of a width of 30 μm and 10 m from the steel sheet surface in the sheet thickness direction is selected and that observed surface is analyzed by EPMA. Among the oxides observed there, the ones with Si contents of 5 wt % or more are defined as Si oxides, their shapes (in particular long axes and short axes) are measured, average particle size 1 μm or more Si oxides are identified and their area ratio in the observed surface is calculated. Here, the “average particle size” is the area circle equivalent size (area equivalent circle diameter). In the same stainless steel sheet, any three or more observed surfaces may be selected and the area ratios of the Si oxides obtained there may be arithmetically averaged to find it. The method of measurement of the number is not particularly limited, but a photo obtained by EPMA may be input to photo editing software (for example, ImageJ) and the photo digitized and measured by image processing software.

### <Intergranular Cracking Length>

As a result of suppression of nitriding of the steel sheet surface, intergranular cracking due to penetration of nitrogen (N) is suppressed. Intergranular cracking can be measured for length by observing the crystal grain boundaries. Ranges of 50 μm square are selected at any three locations of the surface layer parts of the steel sheet cross-section (parts including at least nitrided parts). The total of the intergranular cracking lengths at these may be 15 μm or less. If the total of the intergranular cracking lengths at the three locations of the observed surface is 15 μm or less, it is possible to suppress the embrittlement of the steel sheet surface and possible to secure steel sheet strength at a 500 to 700 °C temperature region. The shorter the total of the intergranular cracking lengths, the better. The total is more preferably 14 μm or less, 13 μm or less, 12 μm or less, 11 μm or less, or 10 μm or less.

The intergranular cracking length of the steel sheet surface layer part can be measured as follows: A cross-section of the steel sheet used as a sample is observed under an optical microscope at an observed field of a 50 μm square region and the intergranular cracking length is measured. At that time, the closer to the steel sheet surface, the greater the susceptibility to the effects of nitrogen, so the part corresponding to the area right under the steel sheet surface may be made the observed field. At the time of measurement, image processing is preferably used for measurement. For example, the intergranular cracking part may be marked on the measurement image and image processing used for measuring its length.

### <Nitridation Depth>

The steel sheet according to the present invention is adjusted in composition so that nitriding is suppressed and has an Si oxide coating at its surface, so the nitriding depth becomes shallower if averaged. In particular, clearly the smaller the value of the nitriding trend index (including also negative values), the shallower the nitriding depth tends to become. The nitriding depth differs somewhat even by the nitrogen (N) content of the gas contacted, but it was confirmed that surface embrittlement is suppressed if it is 100 μm or less. The nitriding depth preferably may be made 95 μm or less, 90 μm or less, 85 μm or less, or 80 μm or less.

### <Method of Production>

Next, the method of production will be explained. The method of production explained below is one embodiment for obtaining the steel sheet according to the present invention and is not limited to this method of production. The method of production is not limited so long as the steel sheet according to the present invention is obtained.

One embodiment of the method of production of the steel sheet according to the present invention comprises producing steel sheet by an ordinary method, then forming an Si oxide layer by internal oxidation under the steel sheet surface layer by final annealing, forming a Cr oxide layer and Fe oxide layer above it (steel sheet surface side), and etching away the Cr oxide layer and Fe oxide layer by pickling after the final annealing. Due to this, steel sheet according to the present invention can be obtained by the Si oxide layer appearing on the surface to form the Si oxide coating.

The steel sheet before the final annealing may be produced by an ordinary method of production. For example, it can be produced by the steps of steelmaking-hot rolling, steelmaking-hot rolling-annealing, or steelmaking-hot rolling-pickling-cold rolling.

However, in steelmaking, steel containing constituents adjusted to give the composition explained above is smelted in a converter or electric arc furnace, then is suitably secondarily refined. The molten steel adjusted to the predetermined composition in this way is cast into a slab in accordance with a known method (for example, the continuous casting method). The slab is heated to a predetermined temperature and hot rolled to a predetermined sheet thickness. After hot rolling, the sheet may if necessary also be cold rolled. The cold rolling may also be performed by an ordinary method.

The conditions in the production process may be suitably selected. For example, the slab thickness, hot rolled sheet thickness, etc. may be suitably set. After coiling, the hot rolled sheet may be dipped in a water cooling pool. The pickling step after the hot rolling or after the hot rolling and annealing is not particularly limited. Shot blasting, bending, brushing, or other mechanical descaling method may be suitably selected. The pickling solution after the hot rolling is also not particularly limited, but for example sulfuric acid, nitrofluoric acid, or other existing conditions are possible. Furthermore, after that, coil grinding may also be performed on the surface.

The thus obtained hot rolled steel sheet, hot rolled annealed steel sheet, or cold rolled steel sheet is final annealed. The annealing atmosphere is not particularly limited. The air atmosphere is also possible. The annealing may also be performed at a temperature of a temperature 900 to 1100 °C. The holding time is not particularly limited, but preferably may be made 30 seconds to 5 minutes. By annealing the sheet in this temperature region, an Si oxide layer is formed under the steel sheet surface (internal oxidation). Furthermore, at the top layer of the Si oxide layer (steel sheet surface side), a Cr oxide layer is formed due to the diffusion of the Cr in the steel sheet and an Fe oxide layer is formed due to the Fe in the steel sheet.

After the final annealing, the steel sheet is cooled down to 60 °C or less and pickled to etch off the top layer Cr oxide layer and Fe oxide layer. For this reason, the pickling solution may be a pickling solution containing hydrofluoric acid (HF) in 2.0% or less and nitric acid in 6 to 15% adjusted to give a temperature of 50 to 60 °C and dipping time of 50 to 80 seconds. Due to this, the top layer Fe oxides and Cr oxides are removed, the internally oxidized Si oxide layer appears at the surface layer, and an Si oxide coating of a suitable area ratio is formed. Fluoric acid need not be contained, but if Si oxides excessively remain, not only does surface coloration cause deterioration of the design sense, but also the workability and weldability deteriorate. For this reason, the pickling solution may preferably be made to contain fluoric acid in 0.10% or more, preferably 0.2% or more, 0.3% or more, 0.4% or more, or 0.5% or more to dissolve part of the Si oxides and suitably leave the Si oxide coating. If the HF is too great, Si oxides are excessively removed, so the content may be made 2.0% or less, preferably 1.5% or less or 1.0% or less.

Furthermore, a brushing step for brushing the steel sheet surface may be added after the pickling. By brushing the steel sheet surface, it is possible to reliably remove the top layer Fe oxides and Cr oxides and adjust the amount of removal as well, so it is possible to expose the Si oxidation coating at the steel sheet surface by the desired area ratio. The brushing may be brushing at least at part of the steel sheet surface or may be performed over the entire steel sheet surface. Further, it may be performed at one of the front and back surfaces of the steel sheet or at both.

The type of the brushing use brush is not particularly limited. The brush may be selected from the difference in hardness of the Fe oxides and Cr oxides to be removed and the Si oxides to be left. This is because by doing this, it is possible to selectively remove Fe oxides and Cr oxides without removing the surface Si oxides. For example, an abrasive brush with abrasives adjusted in roughness etc. may be applied.

### <Applications>

The steel sheet according to the present invention has little penetration of nitrogen of the steel sheet surface layer and suppressed intergranular cracking due to its excellent nitriding resistance even if used in a gas environment with a large nitrogen (N) content. Furthermore, it is also provided with oxidation resistance. This is effective even against the formation of red scale in conventional stainless steel in particular in a 500 to 700 °C or so medium to high temperature region. Due to this, for example, this can be used for combustion equipment of ammonia which has a high nitrogen content and a gas temperature of a 500 to 700 °C medium to high temperature region. In particular, it can be used for exhaust parts of ammonia combustion equipment etc.

Of course, due to the properties of nitriding resistance and oxidation resistance, even if used for containers, piping parts, etc. directly contacting ammonia, urea, etc., the nitrogen ions in the solution or nitrogen in the evaporated gas of ammonia or urea are kept from penetrating the steel sheet surface layer and intergranular cracking is suppressed.

In addition, this effect can be obtained if applying the steel sheet according to the present invention to a part requiring nitriding resistance and oxidation resistance.

### EXAMPLES

Below, examples will be used to explain the present invention more specifically, but the present invention is not limited to these examples.

Steel of the chemical composition shown in Table 1 was smelted and cast into a slab then the slab was hot rolled to obtain a sheet thickness 4 mm hot rolled steel sheet. After that, the hot rolled steel sheet was annealed at a 900 to 1100 °C temperature and was pickled and cold rolled to obtain a sheet thickness 1.5 mm cold rolled steel sheet. The obtained cold rolled steel sheet was annealed at a 900 to 1100 °C temperature (final annealing), then was dipped in a 50 to 60 °C pickling solution (2% fluoric acid+10% nitric acid+water) for 50 to 80 seconds (final pickling) and rinsed to obtain a test material. The solution temperature condition and dipping time of the final pickling were shown in Table 2.

After the final pickling, the surface was brushed to finish it. The brushing was performed using a brush with SiC abrasives attached by a load current of 80 to 120 A, speed of 1000 rpm, and reduction of 0.5 to 1.0 mm.

From the obtained test material, four 20 mm×25 mm test pieces were cut out. One was used for measuring the area ratio of the surface Si oxide coating while the remaining three were used for nitriding and oxidation envisioning ammonia combustion gas.

The area ratio of the Si oxide coating at the steel sheet surface was measured by EPMA. This was measured under the conditions of acceleration voltage: 15 kV, probe current: 2.0×10⁻⁷ A, analysis area: 30 μm×30 μm, and measurement time: 50 ms. The Si oxide coating (SiO₂) was judged from the obtained image, the image was digitized by photo editing software (ImageJ), then image processing software was used to find the area ratio with respect to the area of the observed field.

The nitriding and oxidation treatment was performed by introducing into an annealing furnace a gas of the atmospheric gas plus ammonia 10 vol %, water vapor 10 vol %, balance nitrogen (N), placing the remaining test pieces in the furnace, heating to a temperature of 600 °C, then holding for 50 hours, then cooling and taking out the test pieces and measuring the intergranular cracking length and nitriding depth.

The intergranular cracking length was determined by cutting a test piece after nitriding and oxidation so enable a cross-section in the sheet thickness direction to be observed and using an optical microscope to examine the cross-section of the test piece. In the examination, a range of 50 μm×50 μm right below the steel sheet surface is used as one field, three randomly selected locations in the cross-section of the sample are examined, and the lengths of intergranular cracking occurring were measured. If the total of the intergranular cracking lengths at the three locations of observed surfaces is m or less, the sample was judged as good.

The nitriding depth was determined by cutting a test piece after nitriding and oxidation, electrolytically etching it in a 10% oxalic acid aqueous solution by a voltage of 6V for 5 seconds, and examining the piece using an optical microscope. The nitriding depth was measured using a photograph.

The red scaling was checked for visually. A piece where red scale could not be found was judged as passing (“pass”) while a piece where red scale could be found, even slightly, was judged as failing (“fail”). The measurement results are shown in Table 2. From the data of Table 2, it will be understood that the steel sheet according to the present invention is reduced in intergranular cracking length.

TABLE 1

| Steel | Composition (mass %) (bal.: Fe & impurities) | | | | | | | | | | | | | |
|---|---|---|---|---|---|---|---|---|---|---|---|---|---|---|
| no. | C | Si | Mn | P | S | Ni | Cr | N | Nb | Mo | Cu | Al | Ti | Others |
| 1 | 0.050 | 3.28 | 0.78 | 0.025 | 0.0004 | 13.80 | 19.03 | 0.021 | 0.05 | 0.15 | 0.14 | 0.023 | 0.005 | |
| 2 | 0.056 | 0.80 | 1.22 | 0.018 | 0.0011 | 19.16 | 26.09 | 0.016 | 0.01 | 0.01 | — | 0.008 | 0.020 | Sn: 0.13 |
| 3 | 0.097 | 1.92 | 1.47 | 0.027 | 0.0004 | 12.18 | 24.37 | 0.221 | 0.00 | 0.60 | 0.23 | 0.121 | 0.01 | B: 0.0009 |
| 4 | 0.055 | 1.81 | 0.71 | 0.002 | 0.0009 | 11.02 | 20.01 | 0.011 | 0.13 | 0.03 | 0.08 | 0.012 | 0.020 | REM: 0.097, Mg: 0.0029 |
| 5 | 0.060 | 2.45 | 0.81 | 0.029 | 0.0010 | 9.01 | 18.09 | 0.025 | 0.01 | 0.01 | 0.12 | 0.630 | 0.010 | V: 0.25 |
| 6 | 0.061 | 2.11 | 1.08 | 0.024 | 0.0010 | 10.01 | 18.02 | 0.013 | — | 0.81 | 2.01 | 0.041 | 0.420 | Ca: 0.0006, Ga: 0.15 |
| 7 | 0.063 | 2.08 | 0.81 | 0.029 | 0.0010 | 13.10 | 18.12 | 0.018 | 0.00 | 0.91 | 2.06 | 0.021 | 0.010 | Hf: 0.18 |
| 8 | 0.071 | 2.01 | 1.56 | 0.019 | 0.0007 | 13.09 | 21.07 | 0.198 | 0.28 | 1.89 | 0.16 | 0.029 | — | Zr: 0.39, Sb: 0.09 |
| 9 | 0.069 | 3.01 | 0.77 | 0.023 | 0.0008 | 14.10 | 18.81 | 0.031 | 0.09 | 0.89 | 2.23 | 0.034 | 0.010 | Co: 0.34, Ta: 0.29 |
| 10 | 0.053 | 4.11 | 1.51 | 0.027 | 0.0004 | 13.91 | 18.01 | 0.029 | 0.01 | 0.02 | 3.39 | 0.041 | 0.020 | W: 1.01 |
| 11 | 0.049 | 4.45 | 0.98 | 0.029 | 0.0010 | 15.12 | 19.01 | 0.021 | 0.01 | — | — | 0.019 | 0.010 | |
| 12 | 0.211 | 0.81 | 0.41 | 0.030 | 0.0010 | 8.09 | 14.56 | 0.031 | 0.03 | 3.01 | 0.21 | 0.991 | 0.001 | |
| 13 | 0.081 | 0.80 | 2.55 | 0.028 | 0.0020 | 14.12 | 18.09 | 0.029 | 0.01 | 4.21 | 0.11 | 0.032 | 0.002 | |
| 14 | 0.090 | 0.58 | 2.99 | 0.031 | 0.0020 | 23.03 | 33.01 | 0.018 | 0.01 | 1.09 | 1.09 | 0.081 | 0.080 | |
| 15 | 0.081 | 0.51 | 2.09 | 0.028 | 0.0010 | 15.07 | 18.01 | 0.022 | 0.02 | 0.01 | 4.09 | 1.690 | 0.010 | |
| 16 | 0.061 | 0.29 | 0.51 | 0.031 | 0.0010 | 10.88 | 17.99 | 0.034 | 0.51 | 0.98 | 0.02 | 0.079 | 1.450 | |
| 17 | 0.095 | 0.44 | 4.19 | 0.039 | 0.0020 | 11.09 | 20.12 | 0.029 | 1.31 | 2.95 | 0.02 | 0.090 | 0.003 | |
| 18 | 0.091 | 5.31 | 3.21 | 0.029 | 0.0020 | 18.99 | 25.02 | 0.029 | 0.01 | 3.78 | 0.03 | 0.310 | 0.004 | |
| 19 | 0.041 | 0.81 | 0.81 | 0.035 | 0.0010 | 9.01 | 25.11 | 0.018 | 0.00 | 2.01 | 0.00 | 0.021 | 0.010 | |
| 20 | 0.061 | 2.01 | 1.01 | 0.039 | 0.0010 | 11.98 | 18.09 | 0.017 | 0.00 | 0.15 | 0.00 | 0.008 | 0.000 | |
| 21 | 0.082 | 1.09 | 1.95 | 0.036 | 0.0010 | 10.01 | 20.01 | 0.021 | 0.01 | 3.51 | 0.00 | 0.031 | 0.010 | |

TABLE 2

| | | | Pickling condition | | | | | | | |
|---|---|---|---|---|---|---|---|---|---|---|
| | | | Solution | | Surface Si oxide | Surface layer Si | Intergranular | | Nitridation | |
| Sample | Steel | Nitridation | temp. | Time | coating area ratio | oxide area ratio | cracking length | Red | depth | |
| no. | no. | trend index | (°C) | (sec) | (%) | (%) | (μm) | scaling | (μm) | Remarks |
| Sample 1 | 1 | 5.2 | 60 | 60 | 12.8 | 15.1 | 0 | Pass | 59 | Ex. |
| Sample 2 | 2 | 12.0 | 50 | 50 | 8.6 | 7.0 | 8 | Pass | 71 | Ex. |
| Sample 3 | 3 | 11.9 | 50 | 50 | 10.3 | 11.4 | 13 | Pass | 70 | Ex. |
| Sample 4 | 4 | 7.6 | 50 | 50 | 9.8 | 12.3 | 3 | Pass | 69 | Ex. |
| Sample 5 | 5 | 11.8 | 60 | 60 | 10.2 | 12.7 | 5 | Pass | 81 | Ex. |
| Sample 6 | 6 | 10.1 | 50 | 60 | 11.3 | 10.9 | 0 | Pass | 75 | Ex. |
| Sample 7 | 7 | 9.0 | 50 | 60 | 9.5 | 9.8 | 0 | Pass | 50 | Ex. |
| Sample 8 | 8 | 11.7 | 50 | 60 | 14.1 | 8.7 | 9 | Pass | 89 | Ex. |
| Sample 9 | 9 | 8.2 | 60 | 60 | 16.3 | 13.1 | 0 | Pass | 51 | Ex. |
| Sample 10 | 10 | 5.0 | 60 | 80 | 18.7 | 10.4 | 0 | Pass | 59 | Ex. |
| Sample 11 | 11 | 3.1 | 60 | 80 | 19.1 | 17.1 | 0 | Pass | 36 | Ex. |
| Sample 12 | 12 | 22.1 | 40 | 90 | 3.1 | 2.5 | 22 | Fail | 119 | Comp. ex. |
| Sample 13-1 | 13 | 16.6 | 40 | 40 | 21.5 | 2.7 | 25 | Pass | 104 | Comp. ex. |
| Sample 13-2 | 13 | 16.6 | 60 | 60 | 7.4 | 1.9 | 31 | Pass | 113 | Comp. ex. |
| Sample 14 | 14 | 19.4 | 50 | 90 | 0.9 | 0.8 | 26 | Fail | 113 | Comp. ex. |
| Sample 15 | 15 | 27.2 | 60 | 90 | 1.5 | 0.6 | 27 | Fail | 129 | Comp. ex. |
| Sample 16 | 16 | 15.7 | 60 | 60 | 1.8 | 0.5 | 18 | Fail | 106 | Comp. ex. |
| Sample 17 | 17 | 16.2 | 70 | 80 | 1.1 | 0.8 | 21 | Fail | 105 | Comp. ex. |
| Sample 18 | 18 | 15.2 | 60 | 40 | 47.8 | 26.9 | 19 | Pass | 118 | Comp. ex. |
| Sample 19-1 | 19 | 15.6 | 50 | 50 | 5.4 | 2.0 | 20 | Pass | 108 | Comp. ex. |
| Sample 19-2 | 19 | 15.6 | 60 | 90 | 2.1 | 1.5 | 19 | Fail | 119 | Comp. ex. |
| Sample 20 | 20 | 6.4 | 60 | 90 | 4.1 | 2.3 | 2 | Fail | 65 | Comp. ex. |
| Sample 21 | 21 | 15.7 | 50 | 5.5 | 6.1 | 16.6 | 22 | Pass | 104 | Comp. ex. |

### INDUSTRIAL APPLICABILITY

The present invention can be utilized in the automobile industry, general machinery industry, and all sorts of other industries.

1. Austenitic stainless steel sheet containing, by mass %,
C: 0 to 0.150%,
Si: 0.05 to 4.50%,
Mn: 0.05 to 3.00%,
P: 0.050% or less,
S: 0.0050% or less,
Ni: 8.00 to 21.00%,
Cr: 15.0 to 30.0%,
N: 0 to 0.350%,
Nb: 0 to 1.00%
Mo: 0 to 3.00%
Cu: 0 to 3.50%
Al: 0.002 to 0.800%,
Ti: 0 to 0.600%
V: 0 to 1.00%,
B: 0 to 0.0100%,
Ca: 0 to 0.0150%
Sn: 0 to 1.00%,
Hf: 0 to 0.60%,
Zr: 0 to 0.60%,
Sb: 0 to 0.60%,
Co: 0 to 1.50%,
W: 0 to 2.00%,
Ta: 0 to 1.00%,
Ga: 0 to 0.50%,
Mg: 0 to 0.0050%, and
REM: 0 to 0.20%,
satisfying formula 1,
comprising a balance of Fe and impurities,
satisfying the following formula 1, and
having an Si oxide coating on the surface, when viewing the steel sheet surface from vertically above, present in an area % of 5.0% or more:
0.5Cr+10Al+2Mo+3Ti+0.5Cu−1.5Si≤15.0 (formula 1)
where, the element symbols in formula 1 indicate the contents (mass %) of those elements, 0 being entered when not contained.

2. The austenitic stainless steel sheet according to claim 1, wherein particle size 1 μm or more Si oxides are present in an area ratio of 3.0% or more at a cross-section vertical to the steel sheet surface in a region of a width of 30 μm and down 10 μm from the steel sheet surface in the steel sheet thickness direction.

3. The austenitic stainless steel sheet according to claim 1, wherein a range of 50 μm square at a cross-section in a sheet thickness direction of the steel sheet is made one field and a total of lengths of intergranular cracks of any three fields is 15 μm or less.

4. The austenitic stainless steel sheet according to claim 1, wherein the Si oxide coating is present in an area ratio of 50% or less.

5. The austenitic stainless steel sheet according to claim 1, for use for ammonia combustion equipment.

6. The method for producing austenitic stainless steel sheet according to claim 1, the method for producing austenitic stainless steel sheet comprising, after final cold rolling, heating and holding steel sheet having a composition containing, by mass %,
C: 0 to 0.150%,
Si: 0.05 to 4.50%,
Mn: 0.05 to 3.00%,
P: 0.050% or less,
S: 0.0050% or less,
Ni: 8.00 to 21.00%,
Cr: 15.0 to 30.0%,
N: 0 to 0.350%,
Nb: 0 to 1.00%
Mo: 0 to 3.00%
Cu: 0 to 3.50%
Al: 0.002 to 0.800%,
Ti: 0 to 0.600%
V: 0 to 1.00%,
B: 0 to 0.0100%,
Ca: 0 to 0.0150%
Sn: 0 to 1.00%,
Hf: 0 to 0.60%,
Zr: 0 to 0.60%,
Sb: 0 to 0.60%,
Co: 0 to 1.50%,
W: 0 to 2.00%,
Ta: 0 to 1.00%,
Ga: 0 to 0.50%,
Mg: 0 to 0.0050%, and
REM: 0 to 0.20%,
satisfying formula 1,
comprising a balance of Fe and impurities,
satisfying the following formula 1, and
having an Si oxide coating on the surface, when viewing the steel sheet surface from vertically above, present in an area % of 5.0% or more:
0.5Cr+10Al+2Mo+3Ti+0.5Cu−1.5Si≤15.0 (formula 1)
where, the element symbols in formula 1 indicate the contents (mass %) of those elements, 0 being entered when not contained,
to 900 to 1100 °C, then cooling the steel sheet to a 50 °C or less temperature and pickling the steel sheet in a pickling solution containing fluoric acid 2.0% or less and nitric acid 6 to 15% and having a temperature of 50 to 60 °C for 50 to 80 seconds in a pickling step.

7. The method for producing austenitic stainless steel sheet according to claim 6, further comprising brushing at least part of the steel sheet surface after the pickling step.

8. A part having, at least portion thereof, the austenitic stainless steel sheet according to claim 1.

9. The part according to claim 8, which is a part for ammonia combustion equipment.

10. The austenitic stainless steel sheet according to claim 2, wherein a range of 50 μm square at a cross-section in a sheet thickness direction of the steel sheet is made one field and a total of lengths of intergranular cracks of any three fields is 15 μm or less.

11. The austenitic stainless steel sheet according to claim 2, wherein the Si oxide coating is present in an area ratio of 50% or less.

12. The austenitic stainless steel sheet according to claim 3, wherein the Si oxide coating is present in an area ratio of 50% or less.

13. The austenitic stainless steel sheet according to claim 2, for use for ammonia combustion equipment.

14. The austenitic stainless steel sheet according to claim 3, for use for ammonia combustion equipment.

15. The austenitic stainless steel sheet according to claim 4, for use for ammonia combustion equipment.

16. The method for producing austenitic stainless steel sheet according to claim 2, the method for producing austenitic stainless steel sheet comprising, after final cold rolling, heating and holding steel sheet having a composition containing, by mass %,
C: 0 to 0.150%,
Si: 0.05 to 4.50%,
Mn: 0.05 to 3.00%,
P: 0.050% or less,
S: 0.0050% or less,
Ni: 8.00 to 21.00%,
Cr: 15.0 to 30.0%,
N: 0 to 0.350%,
Nb: 0 to 1.00%
Mo: 0 to 3.00%
Cu: 0 to 3.50%
Al: 0.002 to 0.800%,
Ti: 0 to 0.600%
V: 0 to 1.00%,
B: 0 to 0.0100%,
Ca: 0 to 0.0150%
Sn: 0 to 1.00%,
Hf: 0 to 0.60%,
Zr: 0 to 0.60%,
Sb: 0 to 0.60%,
Co: 0 to 1.50%,
W: 0 to 2.00%,
Ta: 0 to 1.00%,
Ga: 0 to 0.50%,
Mg: 0 to 0.0050%, and
REM: 0 to 0.20%,
satisfying formula 1,
comprising a balance of Fe and impurities,
satisfying the following formula 1, and
having an Si oxide coating on the surface, when viewing the steel sheet surface from vertically above, present in an area % of 5.0% or more:
0.5Cr+10Al+2Mo+3Ti+0.5Cu−1.5Si≤15.0 (formula 1)
where, the element symbols in formula 1 indicate the contents (mass %) of those elements, 0 being entered when not contained,
to 900 to 1100 °C, then cooling the steel sheet to a 50 °C or less temperature and pickling the steel sheet in a pickling solution containing fluoric acid 2.0% or less and nitric acid 6 to 15% and having a temperature of 50 to 60 °C for 50 to 80 seconds in a pickling step.

17. The method for producing austenitic stainless steel sheet according to claim 3, the method for producing austenitic stainless steel sheet comprising, after final cold rolling, heating and holding steel sheet having a composition containing, by mass %,
C: 0 to 0.150%,
Si: 0.05 to 4.50%,
Mn: 0.05 to 3.00%,
P: 0.050% or less,
S: 0.0050% or less,
Ni: 8.00 to 21.00%,
Cr: 15.0 to 30.0%,
N: 0 to 0.350%,
Nb: 0 to 1.00%
Mo: 0 to 3.00%
Cu: 0 to 3.50%
Al: 0.002 to 0.800%,
Ti: 0 to 0.600%
V: 0 to 1.00%,
B: 0 to 0.0100%,
Ca: 0 to 0.0150%
Sn: 0 to 1.00%,
Hf: 0 to 0.60%,
Zr: 0 to 0.60%,
Sb: 0 to 0.60%,
Co: 0 to 1.50%,
W: 0 to 2.00%,
Ta: 0 to 1.00%,
Ga: 0 to 0.50%,
Mg: 0 to 0.0050%, and
REM: 0 to 0.20%,
satisfying formula 1,
comprising a balance of Fe and impurities,
satisfying the following formula 1, and
having an Si oxide coating on the surface, when viewing the steel sheet surface from vertically above, present in an area % of 5.0% or more:
0.5Cr+10Al+2Mo+3Ti+0.5Cu−1.5Si≤15.0 (formula 1)
where, the element symbols in formula 1 indicate the contents (mass %) of those elements, 0 being entered when not contained,
to 900 to 1100 °C, then cooling the steel sheet to a 50 °C or less temperature and pickling the steel sheet in a pickling solution containing fluoric acid 2.0% or less and nitric acid 6 to 15% and having a temperature of 50 to 60 °C for 50 to 80 seconds in a pickling step.

18. The method for producing austenitic stainless steel sheet according to claim 4, the method for producing austenitic stainless steel sheet comprising, after final cold rolling, heating and holding steel sheet having a composition containing, by mass %,
C: 0 to 0.150%,
Si: 0.05 to 4.50%,
Mn: 0.05 to 3.00%,
P: 0.050% or less,
S: 0.0050% or less,
Ni: 8.00 to 21.00%,
Cr: 15.0 to 30.0%,
N: 0 to 0.350%,
Nb: 0 to 1.00%
Mo: 0 to 3.00%
Cu: 0 to 3.50%
Al: 0.002 to 0.800%,
Ti: 0 to 0.600%
V: 0 to 1.00%,
B: 0 to 0.0100%,
Ca: 0 to 0.0150%
Sn: 0 to 1.00%,
Hf: 0 to 0.60%,
Zr: 0 to 0.60%,
Sb: 0 to 0.60%,
Co: 0 to 1.50%,
W: 0 to 2.00%,
Ta: 0 to 1.00%,
Ga: 0 to 0.50%,
Mg: 0 to 0.0050%, and
REM: 0 to 0.20%,
satisfying formula 1,
comprising a balance of Fe and impurities,
satisfying the following formula 1, and
having an Si oxide coating on the surface, when viewing the steel sheet surface from vertically above, present in an area % of 5.0% or more:
0.5Cr+10Al+2Mo+3Ti+0.5Cu−1.5Si≤15.0 (formula 1)
where, the element symbols in formula 1 indicate the contents (mass %) of those elements, 0 being entered when not contained,
to 900 to 1100 °C, then cooling the steel sheet to a 50 °C or less temperature and pickling the steel sheet in a pickling solution containing fluoric acid 2.0% or less and nitric acid 6 to 15% and having a temperature of 50 to 60 °C for 50 to 80 seconds in a pickling step.

19. A part having, at least portion thereof, the austenitic stainless steel sheet according to claim 2.

20. A part having, at least portion thereof, the austenitic stainless steel sheet according to claim 3.
